(19) United States
(12) Patent Application Publication
(10) Pub. No.: US 2014/0006942 A1
(43) Pub. Date: Jan. 2, 2014

(54) Computing an Optimal Font-Size for Content Item Text

(71) Applicant: Google Inc., Mountain View, CA (US)

(72) Inventors: Brandon M. Pearcy, San Francisco, CA (US); Nathan P. Lucash, San Francisco, CA (US)

(73) Assignee: Google Inc., Mountain View, CA (US)

(21) Appl. No.: 13/801,696

(22) Filed: Mar. 13, 2013

Related U.S. Application Data
(60) Provisional application No. 61/666,694, filed on Jun. 29, 2012.

(51) Int. Cl. G06F 17/21

(52) U.S. Cl. CPC G06F 17/214
USPC 715/269

(57) ABSTRACT

Methods, systems, and apparatus, including computer programs encoded on a computer storage medium, for computing an optimal font-size for text in a content item. In one aspect, a method includes receiving a request for a content item, identifying a content item eligible to fulfill the request, the identified content item including text, initializing a set of constraints for rendering the identified content item, based on the initialized set of constraints, determining an optimal font-size for rendering text included in the identified content item, and delivering the identified content item and an indication of the determined optimal font-size to a device for presentation.

### CROSS REFERENCE TO RELATED APPLICATIONS

This disclosure claims the benefit of the priority of U.S. Provisional Application Ser. No. 61/666,694, filed Jun. 29, 2012 and entitled “COMPUTING AN OPTIMAL FONT-SIZE FOR CONTENT ITEM TEXT,” which is incorporated herein by reference in its entirety.

### BACKGROUND

This specification relates to computing an optimal font-size for content item text.

Publications (e.g., electronic publications, websites, mobile applications, Internet browser applications, IPTV, digital video, etc.) may include third party content items (e.g., advertisements), for example, to financially support a resource provider's (e.g., a publication provider) operations. Some resource providers do not maintain a third party content infrastructure, and thus depend on content serving entities to recruit third party content sponsors (e.g., advertisers, etc.) and to serve the sponsored content items.

Content sponsors may extend their marketing reach by distributing content items directly to resource providers and/or distributing content items to content serving entities for distribution to resource providers. The content items may be presented alongside resources of a publication and may be designed to draw the attention of publication consumers to drive potential customers to the content sponsor's business.

### SUMMARY

This specification describes technologies relating to computing an optimal font-size for content item text, for example, such as rendered into a content item frame. An optimal font-size may be, for example, a maximum displayable font-size for content item text such that, when the text is rendered within a content item frame having fixed width and height dimensions, truncation of the text is prevented. Various implementations may include corresponding systems, apparatus, methods and computer programs, configured to perform the actions of the methods, encoded on computer storage devices.

In an implementation, one or more processes executing on data processing apparatus may perform operations including receiving a request for a content item, identifying a content item eligible to fulfill the request, the identified content item including text, initializing a set of constraints for rendering the identified content item, based on the initialized set of constraints, determining an optimal font-size for rendering text included in the identified content item, and delivering the identified content item and an indication of the determined optimal font-size to a device for presentation.

These and other implementations can each optionally include one or more of the following features. The identified content item can include a textual advertisement and the request can be received from an application executing on the device. The set of constraints can include two or more degrees of freedom and determining the optimal font-size for rendering text included in the identified content item can include determining an optimal font-size for each configuration of the degrees of freedom, and selecting the configuration that yielded the maximum optimal font-size. The optimal font size can be the maximum optimal font-size and delivering can include delivering the configuration that yielded the maximum optimal font-size to the device. The set of constraints can comprise a quantity of content items to be displayed in a content item frame, a width of the content item frame, a height of the content item frame, one or more resource provider controls, and one or more environmental variables for the user device. The optimal font-size can be the maximum displayable font-size that avoids truncation of text included in the identified content item when the text is rendered in a content item frame. The maximum displayable font-size can be determined based on a map of dimensions that fit a model content item. The model content item can be based on an average amount of text in a sampling of content items contained in a database. The model content item can be based on the 95^{th} percentile of an amount of text in a sampling of content items contained in a database. The model content item can comprise the identified content item. The optimal font-size can prevent a pre-determined percentage of truncations of text included in a plurality of content items.

Particular implementations of the subject matter described in this specification can be implemented so as to realize none, one, or more of the following potential advantages. Displaying the text of content item—for example, a textual advertisement—at an optimal font-size may benefit the content item's sponsor by potentially increasing the click-through-rate and the overall monetization, or return on investment, for that content item. For example, if text included in a textual advertisement is rendered with a less than optimal font-size (e.g., a font-size that is too small), the text may be difficult to read and noticeably smaller than surrounding content. Moreover, a less than optimal font-size may result in an excess of unused whitespace in an advertisement frame (e.g., an AdSense iFrame) and reduce the click-through-rate of advertisements displayed in the frame. On the other hand, if text included in a textual advertisement is rendered at a font-size that is too large, the text may be truncated by a bounding box of the advertisement frame. Truncating textual advertisements may be problematic due to contractual obligations with advertisers to display the entire text of the textual advertisements. Therefore, it may be beneficial to render the text in textual advertisements at an optimal font-size such that the size of the text is maximized without being truncated. Non-truncated text may by more aesthetically pleasing than truncated text and result in a better overall service to users, regardless of monetization performance. In addition, it may be beneficial to determine the font-size that yields advertisers the best performance, highest monetization, and overall satisfaction.

Details of one or more implementations of the subject matter described in this specification are set forth in the accompanying drawings and the description below. Other features, aspects, and potential advantages will become apparent from the description, the drawings, and the claims.

### BRIEF DESCRIPTION OF THE DRAWINGS

FIG. 1 is a block diagram of an example environment in which an optimal font-size for content item text is determined.

FIG. 2 is a user interface including an example of a publication.

FIG. 3A is an example layout of a content item frame within which content item text is rendered using a less than optimal font-size.

FIG. 3B is an example layout of a content item frame within which content item text is rendered using a larger than optimal font-size.

FIG. 3C is an example layout of a content item frame within which content item text is rendered using an optimal font-size.

FIG. 4 is a flowchart of an example process to compute an optimal font-size for use when rendering content item text within a content item frame.

FIG. 5 is a flowchart of an example process to determine a maximum optimal font-size for use when rendering content item text within a content item frame.

FIG. 6 is an example of a generic computer device and a generic mobile computer device.

Like reference numbers and designations in the various drawings indicate like elements.

### DETAILED DESCRIPTION

Overview

This specification relates to computing an optimal font-size for use when rendering content item text within a content item frame. A content item frame may be in the form of any suitable geometric shape. In some implementations, a content item frame is a fixed dimension (e.g., fixed width by height, or W×H) rectangular box on a publication. For example, a content item frame may be a fixed W×H advertisement unit or slot (e.g., an AdSense iFrame) on a resource provider's webpage. When content item text is rendered within, or into, a content item frame, it may be beneficial to determine an optimal font-size for the text. In some implementations, the optimal font-size is the maximum displayable font-size that, when used to render content item text in a content item frame, prevents or avoids truncation of the content item text. In other implementations, the optimal font-size can be the font-size that yields the highest performance, monetization, and overall satisfaction from content sponsors.

A number of parameters may affect the optimal font-size for rendering content item text. Such parameters may include, for example, the dimensions (e.g., width and height) of a content item frame, the number of content items to be displayed in the content item frame, a content item layout, a resource provider's user interface controls (e.g., desired font-face, padding between content items, font-size constraints, etc.) if such controls are specified, and environment variables of a user device the application rendering the content items, operating system, screen resolution, language, etc.).

A set of constraints may be initialized using any suitable number of the parameters noted above. In some implementations, the set of constraints may include both fixed and variable parameters. To determine the optimal font-size, a process can iterate over the various configurations of the constraints. For each explored configuration, an optimal font-size for that configuration can be determined. In some implementations, the optimal font-size is the maximum displayable font-size wherein truncation of the text is avoided when the text is rendered within a content item frame. Once all desired configurations have been explored, the maximum font-size over all the configurations, as well as the configuration tuple (e.g., a tuple of {font face, layout, publisher preferences, etc.}) that yielded the maximum displayable font-size can be determined and delivered to a user device.

Example Operating Environment

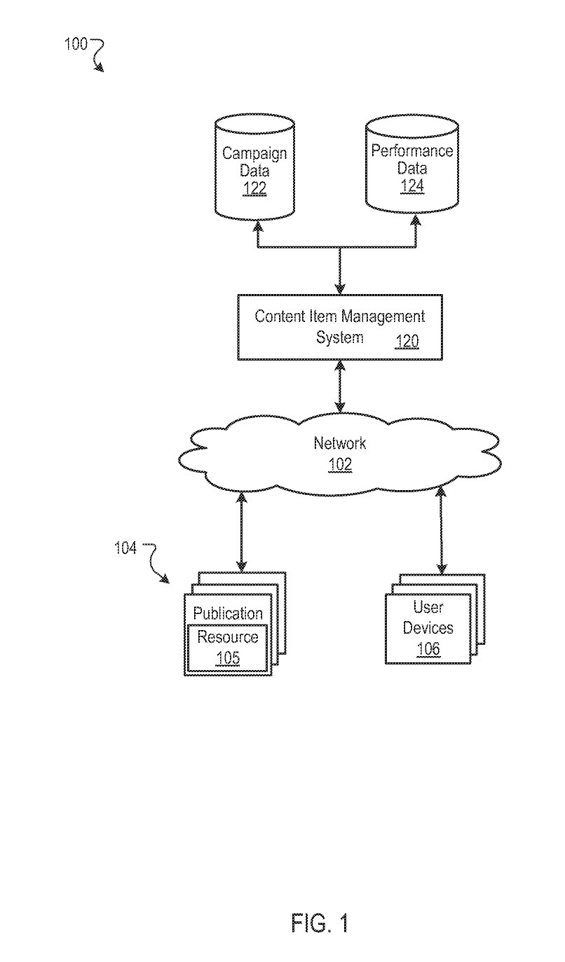

FIG. 1 is a block diagram of an example environment 100 in which an optimal font-size for rendering content item (e.g., advertisement) text is determined. A computer network 102, such as a local area network (LAN), wide area network (WAN), the Internet, or a combination thereof, connects publications 104 from resource providers (e.g., publishers), user devices 106, and an content item management system 120. Publications may include, for example, electronic publications, websites, web pages, mobile applications, Internet browser applications, IPTV, digital videos, and the like. The online environment 100 may include many thousands of publications 104 and user devices 106.

In some implementations, a publication 104 includes one or more resources 105 associated with a domain name and hosted by one or more servers. An example publication is a website including a collection of web pages formatted in hypertext markup language (HTML) that can contain text, images, multimedia content, and programming elements, such as scripts. Each publication 104 is maintained by a resource provider, which is an entity that controls, manages and/or owns the publication 104.

A resource is any data that can be provided by the resource provider with a publication 104 over the network 102 and that is associated with a resource address. Resources include HTML pages, word processing documents, and portable document format (PDF) documents, images, video, and feed sources, to name just a few. The resources can include content, such as words, phrases, pictures, and so on, and may include embedded information (such as meta information and hyperlinks) and/or embedded instructions (such as JavaScript scripts).

A user device 106 is an electronic device that is under the control of a user and is capable of requesting and receiving publications, resources, and content items over the network 102. Example user devices 106 include personal computers, mobile communication devices, and other devices that can send and receive data over the network 102. A user device 106 typically includes a user application, such as a web browser, to facilitate the sending and receiving of data over the network 102. A web browser can enable a user to display and interact with text, images, videos, music and other information typically located on a web page at a website on the world wide web or a local area network.

The content item management system 120 facilitates the provisioning of content items with the publications 104 and resources 105. In particular, content item management system 120 allows content sponsors (e.g., advertisers) to define rules to provide content items that are likely to be of interest to users of user devices 106. Example rules may include keyword selecting, in which content sponsors provide bids for keywords that are present in either search queries or publication content. Content items that are associated with keywords having bids that result in a content item frame (e.g., an AdSense iFrame) being awarded in response to an auction are selected for displaying in the content item frames.

In some implementations, when a user of a user device 106 selects a content item, the user device 106 generates a request for a landing page corresponding to the content item, which is typically a publication of the content sponsor. For example, the publications 104 may include publications from content sponsors, some of which are landing pages for the content items of the content sponsors.

Relevant content items can be provided to user devices for many different resources, such as the resources 105 of the publications 104, and on a search results page publication. For example, a resource 105 of a publication 104 may include instructions that cause a user device 106 to request content items from the content item management system 120. The request includes a resource provider identifier and, optionally, keyword identifiers related to the content of the resources 105. The content item management system 120, in turn, provides relevant content items to the user device 106 where the content item request originated from.

The content item management system 120 includes a data storage system that stores campaign data 122 and performance data 124. The campaign data 122 stores content items, relevancy information, and budgeting information for content sponsors. The performance data 124 stores data indicating the performance of the content items that are served. Such performance data can include, for example, click through rates for content items, the number of impressions for content items, and the number of conversions for content items. Other performance data can also be stored.

The campaign data 122 and the performance data 124 are used as input parameters to a content item auction. In particular, the content item management system 120, in response to each request for content items, conducts an auction to select content items that are provided in response to the request. The content items are ranked according to a score that, in some implementations, is proportional to a value based on a content item bid and one or more parameters specified in the performance data 124. The highest ranked content items resulting from the auction are selected and provided to the requesting user device.

Example Publication

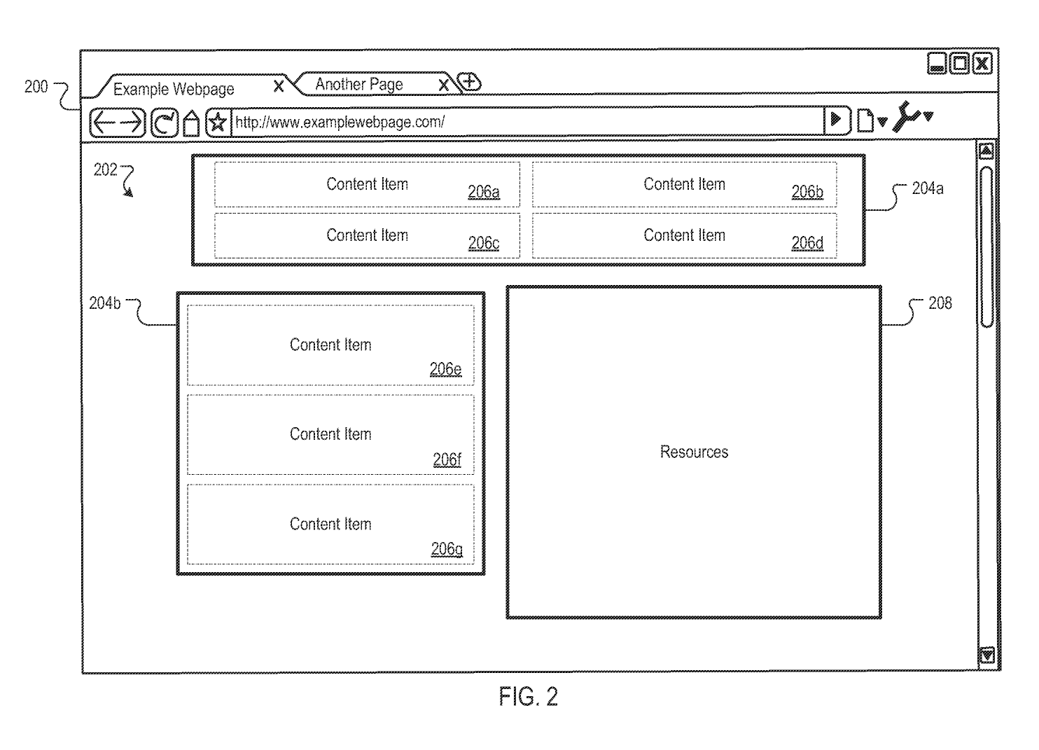

FIG. 2 is a user interface including an example of a publication 202. When rendered on a display output of a user device 105 within a window 200, publication 202 can include one or more content item frames 204a-b alongside resources 208. Each content item frame 204a-b can include one or more of content items 206a-g. Content item frames 204a-b can be in the form of any suitable geometric shape. In some implementations, each content item frame 204a-b is a fixed dimension (width by height) rectangular content item unit/slot embedded in publication 202. For example, content item frames 204a-b may be AdSense iFrames. In some implementations, content items 206a-g may be textual based content items. For example, content items 206a-g may be textual advertisements that include unique content designed or created by content sponsors. In some implementations, publication 202 is a webpage presented in a window 200 of an Internet browser.

Example Content Item Layouts

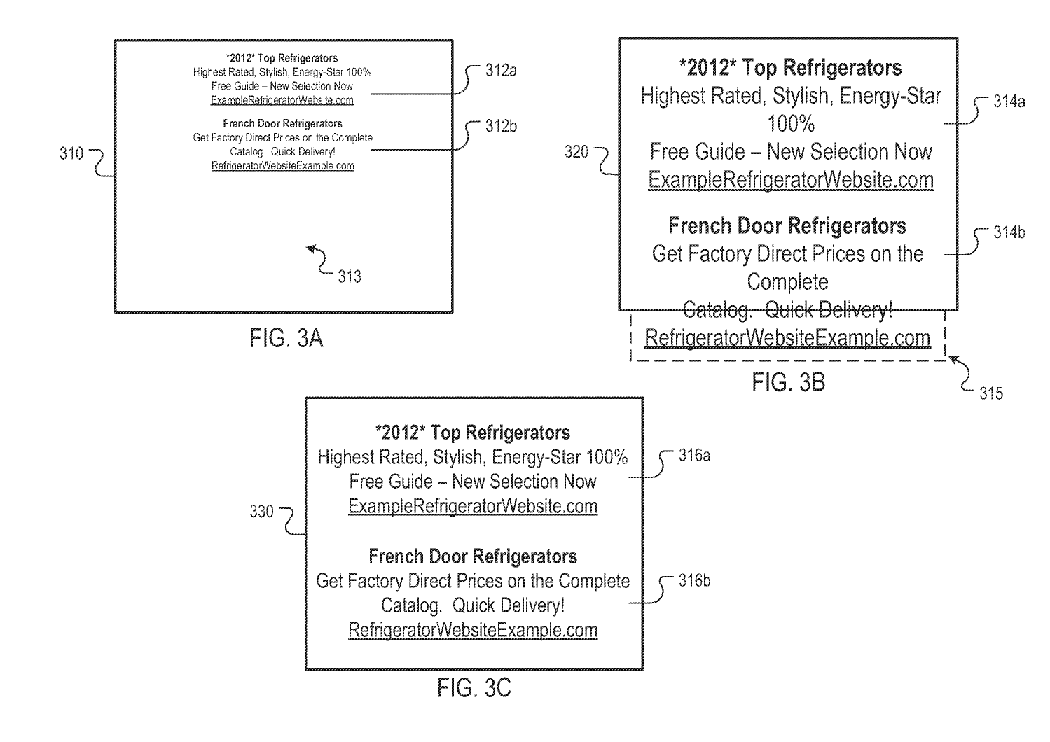

FIG. 3A is an example layout of a content item frame 310 within which content item text is rendered using a less than optimal font-size. In this example, content item frame 310 includes two content items 312a and 312b. Here, the text included in content items 312a and 312b is rendered using a font-size that results in an excess of unused white space 313 in content item frame 310. In some implementations, if content item frame 310 were rendered in a publication, the text of content items 312a and 312b may be difficult to read or smatter than surrounding content included in the publication.

FIG. 3B is an example layout of a content item frame 320 within which content item text is rendered using a larger than optimal font-size. In this example, content item frame 320 includes two content items 314a and 314b. Here, the text included in content items 314a and 314b is rendered using a font-size that results in truncation of the text included in content item 314b. That is, a portion 315 of the text included in content item 314b extends beyond a boundary of content item frame 320. In some implementations, the portion 315 of content item 314b would not be rendered or presented in a publication including content item frame 320.

FIG. 3C is an example layout of a content item frame 330 within which content item text is rendered using an optimal font-size. In this example, content item frame 330 includes two content items 316a and 316b. Here, the text included in content items 316a and 316b is rendered using an optimal font-size. In some implementations, the optimal font-size may be the maximum, or largest, displayable font-size that avoids truncation of the text included in content items 316a and 316b when the text is rendered in content item frame 330. In other implementations, the optimal font-size may take into account a number of parameters corresponding to a content item frame. Such parameters may include, for example, the dimensions (e.g., width and height) of content item frame 330, the number of content items 316a-b to be displayed in content item frame 330, the layout of content items 316a-b, a resource provider's user interface controls (e.g., desired font-face, padding between content items, font-size constraints, etc.) if such controls are specified, and environment variables of a user device (e.g., the application rendering the content items, operating system, screen resolution, language, etc.).

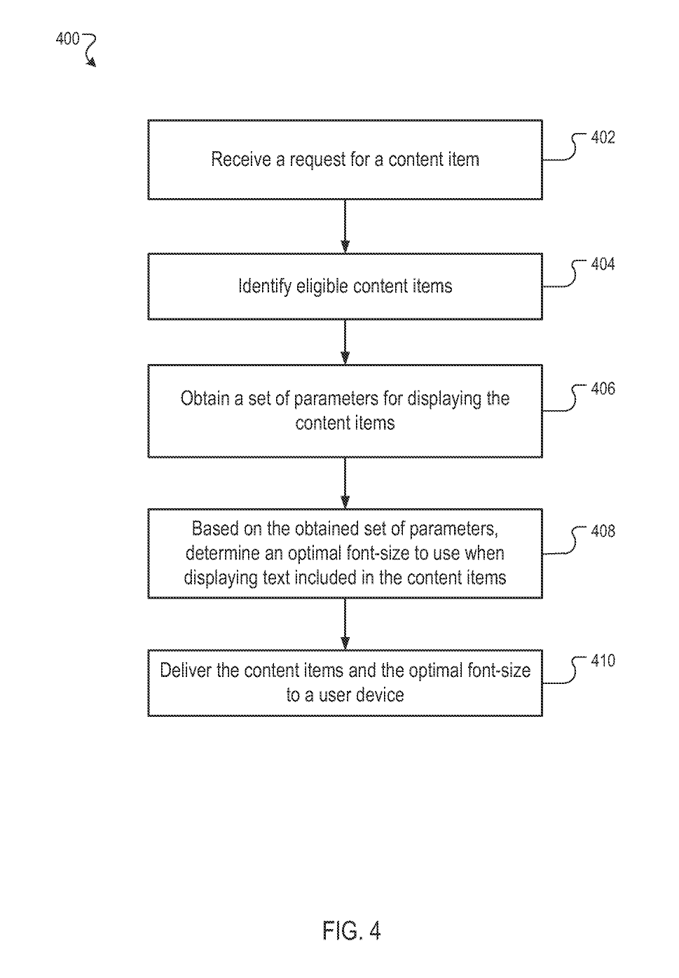

FIG. 4 is a flowchart of an example process 400 to compute an optimal font-size for use when rendering content item text within a content item frame. At 402, the process includes receiving a request for content items. In some implementations, the request can be communicated from a user device (e.g., a user device 106) to a content item management system (e.g., content item management system 120). For example, a resource 105 of a publication 104 may include instructions that cause a user device 106 to request content items from the content item management system 120. In some implementations, the request received at 402 may include additional information. For example, the request may include dimensional values of a content item frame on a publication within which content items will be displayed. The dimensional values may include a width value defining a width of the content item frame and a height value defining a height of the content item frame.

At 404, the process includes identifying eligible content items. In some implementations, the eligible content items are identified based on information submitted with the request received at 402. For example, the information may include a resource provider identifier and/or keyword identifiers. In response to receiving the request at 402, the content item management system can identify content items suitable for rendering within a content item frame. For example, the content items can be identified based on the dimensions of the content item frame within which the content items will be rendered.

At 406, the process includes obtaining a set of content item display parameters that guide the rendering of content items within a content item frame. Various examples of content item display parameters may include font-size constraints, font-faces, text layout, browser types, operating system types, screen resolutions, padding and margin values for content items within a content item frame, user interface controls specified by a resource provider, and the like. Obtaining content item display parameters can include accessing one or more content item display parameters that correspond, respectively, to one or more degrees of freedom. For example, a resource provider can request that all content items displayed in a publication be rendered using a specific font-face such that the text included in the displayed content items matches resources displayed in other portions of the publication.

At 408, the process includes determining an optimal font-size for content items. In some implementations, the optimal font-size may be determined based on the dimensional values of a content item frame and various combinations of the content item frame parameters. For example, the optimal font-size may be the largest, or maximum, displayable font-size that does not result in truncation of the text included in content items. In some implementations, determining an optimal font-size can include determining an optimal font-size for the different combinations of the content item frame parameters, e.g., degrees of freedom. The maximum optimal font-size can be selected as the maximum optimal font-size across the explored degrees of freedom.

At 410, the process includes delivering the content items and an optimal font-size to a user device for display of content items within a content item frame. Delivering the content items and the optimal font-size can include communicating the content item data via Hypertext Transfer Protocol (HTTP) to an application (e.g., an Internet browser) executing on a user device, such as a laptop, tablet, mobile phone, or other suitable computing system. Based on the content item data, the application can render content item text within the content item frame using the optimal font-size.

In some implementations, the process at 408 can iterate over the variable content item frame parameters, (e.g., the degrees of freedom) to determine a maximal optimal font-size. The number of degrees of freedom can be constrained based on a resource providers user interface controls. Such controls can be indicated in the request received at 402 or be retrieved from a database. For example, the resource provider may request that only a specific font-face be used to display text in content items. Accordingly, the font-face degree of freedom is considered to be fixed for this resource provider, and the process, at 408, can iterate over the remaining degrees of freedom.

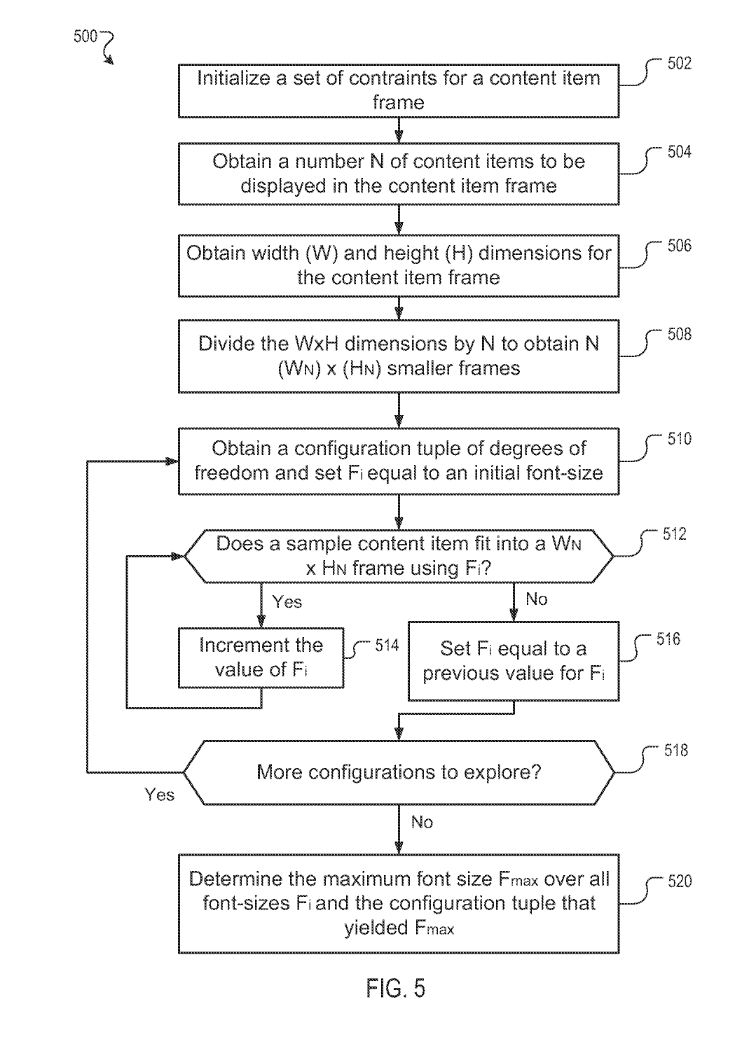

FIG. 5 is a flowchart of an example process 500 to determine a maximum optimal font-size for use when rendering content item text within a content item frame. In some implementations, process 500 determines a maximum font-size based on optimal font sizes determined across the variable content item frame degrees of freedom. At 502, the process initializes a set or constraints based on parameters for a content item frame. The parameters can include, for example, a number N of content items to be rendered in the content item frame, dimensions (e.g., width and height) of the content item frame, a resource provider's user interface controls (e.g., desired font-face, padding between content items, font-size constraints, etc.) if any are specified, and environment variable for a user device (e.g., browser, operating system, screen resolution, language, etc).

At 504, the process obtains a number N of content items to be displayed in the content item frame. At 506, the process obtains dimensions for the content item frame. For example, at 506 the process can obtain the width (W) and height (H) dimensions for the content item frame. Obtaining the number N of content items and the width and height values of the content item frame can include receiving a data packet that specifies these values.

At 508, the process obtains N smaller geometric shapes by dividing the content item frame by the number N of content items to be rendered within the content item frame. For example, at 508 the process can obtain N smaller rectangles with width (W_{N}) and height (H_{N}) by dividing the W×H dimensions for the content item frame by the number N of content items to be rendered within the content item frame. In some implementations, space is removed for padding between the N smaller rectangles.

At 510, the process obtains a configurations tuple comprising values for the remaining degrees of freedom, after initializing the set of constraints. In addition, at 510, the font-size Fi is set equal to an initial font-size value. In some implementations, the process iterates through every possible font-size, starting with some reasonable minimum (e.g., 9 pixels) to some reasonable max (e.g., 15 pixels).

At 512, the process determines whether a sample content item fits into the smaller geometric shapes. For example, a W_{N}×H_{N} smaller rectangle using the font-size Fi. In some implementations, the process can use the W_{N}×H_{N} dimensions of a smaller rectangle to lookup into a map of dimensions that fit a model content item to determine if a content item using the current font-size Fi can fit into the space available. In some implementations, the model content item is based on an average amount of text in a representative sampling of content items in a database. In some implementations, actual content items are used. In some implementations, a model content item is based on a percentile of content items in a database. For example, a model content item size can be based on the 95^{th} percentile of sizes of content items stored in a database. If the sample content item is fully displayable at 512 (e.g., the content item text would avoid truncation when rendered into a smaller rectangle of size W_{N}×H_{N}), the process records this information and increments the value of Fi at 514 and continues at 512 to determine whether the incremented value of Fi fits into the W_{N}×H_{N} rectangle.

In some implementations, an optimal font-size can be determined by combining content items together. For example, larger content items can take advantage of the fact that smaller content items did not utilize their full allotment of content item space (e.g., space in a bounding box). In this manner, an optimal font-size can be determined based on, for example, a number of characters included in a content item.

If the sample content item is not fully displayable at 512 (e.g., a portion of the text is truncated), the process sets Fᵢ equal to the previous value of Fᵢ at 516 and continues at 518 by determining whether there is another configuration that has not been explored. If there is another configuration, the process continues at 510 to obtain the configuration and perform additional processing. If there are no more configurations, the process continues at 520 to determine the maximum font-size Fₘₐₓ over all of the configuration tuples and their corresponding final font-size Fᵢ values. The process can deliver the Fₘₐₓ value and the configuration tuple that yielded the Fₘₐₓ value to a user device such that the user device can render content item text within a content item frame using Fₘₐₓ and the parameters specified in the delivered configuration tuple.

Additional Implementation Details

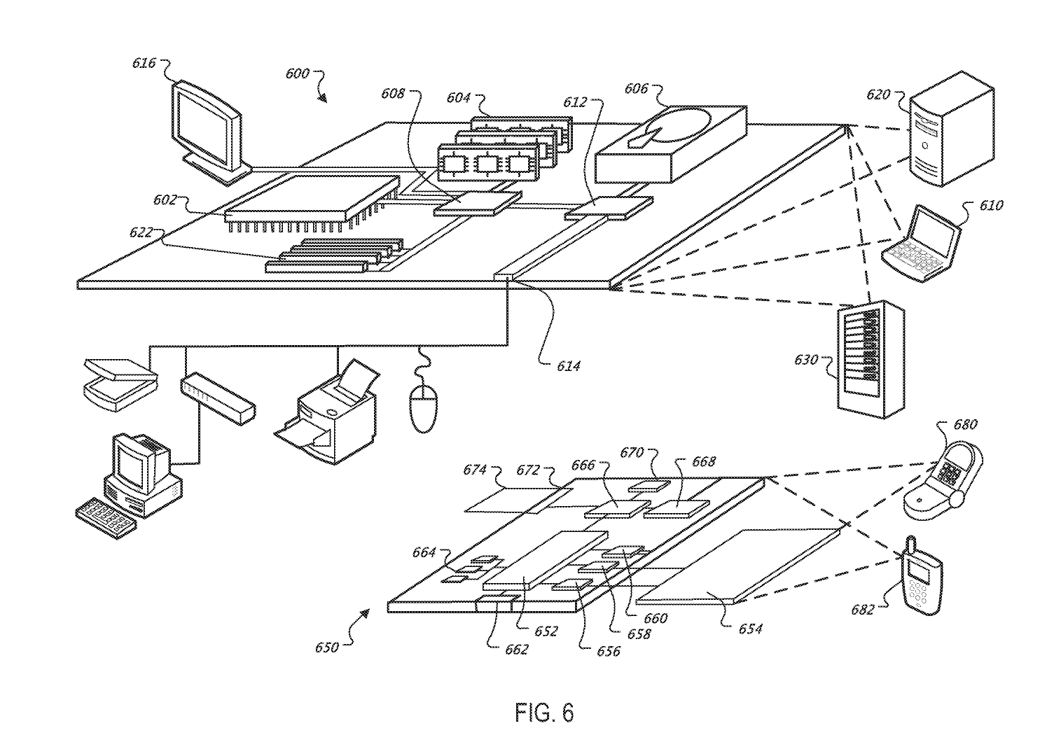

FIG. 6 is an example of a generic computer device 600 and a generic mobile computer device 650, which may be used with the techniques described herein. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, tablets, and other similar computing devices. The components shown here, their connections and relationships, and their functions, are meant to be exemplary only, and are not meant to limit implementations of the inventions described and/or claimed in this document.

Computing device 600 includes a processor 602, memory 604, a storage device 606, a high-speed interface 608 connecting to memory 604 and high-speed expansion ports 622, and a low speed interface 612 connecting to low speed bus 614 and storage device 606. Each of the components 602, 604, 606, 608, 622, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, memory on processor 602, or a propagated signal.

The high speed controller 608 manages bandwidth-intensive operations for the computing device 600, while the low speed controller 612 manages lower bandwidth-intensive operations. Such allocation of functions is exemplary only. In one implementation, the high-speed controller 608 is coupled to memory 604, display 616 (e.g., through a graphics processor or accelerator), and to high-speed expansion ports 622, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 630. In addition, it may be implemented in a personal computer such as a laptop computer 610. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can execute instructions within the computing device 650, including instructions stored in the memory 664. The processor may be implemented as a chipset of chips that include separate and multiple analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD (Thin-Film-Transistor Liquid Crystal Display) or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provided in communication with processor 652, so as to enable near area communication of device 650 with other devices. External interface 662 may provide, for example, for wired communication in some implementations, or for wireless communication in other implementations, and multiple interfaces may also be used.

The memory 664 stores information within the computing device 650. The memory 664 can be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In Line Memory Module) card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, memory on processor 652, or a propagated signal that may be received, for example, over transceiver 668 or external interface 662.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” or “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing, system can include clients and servers. A client and server are generally remote from each other and typically interact through a communication network. The relationship of client and server arises by virtue of computer programs running on the respective computers and having a client-server relationship to each other.

White this specification contains many specific implementation details, these should not be construed as limitations on the scope of any invention or of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementations can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and stilt achieve desirable results. As one example, the processes depicted in the accompanying figures do not necessarily require the particular order shown, or sequential order, to achieve desirable results. In certain implementations, multitasking and parallel processing may be advantageous.

### Alternative Implementations:

In addition, in place of or in addition to using a map of eligible widths and heights, a process could render the text content at each font-size in the user's browser, measure the dimensions immediately, and determine truncation of the content item text is avoided. The process would then terminate at the largest font-size that avoids truncations when rendered into a content item frame.

In other implementations, a process may use a character-width map, which may be computed offline, to determine the total dimensions of the text content included in a content item. This approach would require storing widths for every possible text character (UTF-8 has over a million characters, for example) for every tuple of {browser, font-face, font-size, styling, etc.}.

What is claimed is:

1. A method performed by data processing apparatus, the method comprising:
receiving a request for a content item;
identifying a content item eligible to fulfill the request, the identified content item including text;
initializing a set of constraints for rendering the identified content item;
based on the initialized set of constraints, determining an optimal font-size for rendering text included in the identified content item; and
delivering the identified content item and an indication of the determined optimal font-size to a device for presentation.

2. The method of claim 1, wherein the identified content item comprises a textual advertisement and the request is received from an application executing on the device.

3. The method of claim 1, wherein the set of constraints includes two or more degrees of freedom and determining the optimal font-size for rendering text included in the identified content item includes:
determining an optimal font-size for each configuration of the degrees of freedom; and
selecting the configuration that yielded the maximum optimal font-size.

4. The method of claim 3, wherein the optimal font size is the maximum optimal font-size and wherein delivering includes delivering the configuration that yielded the maximum optimal font-size to the device.

5. The method of claim 1, wherein the set of constraints comprises a quantity of content items to be displayed in a content item frame, a width of the content item frame, a height of the content item frame, one or more resource provider controls, and one or more environmental variables for the user device.

6. The method of claim 1, wherein the optimal font-size is the maximum displayable font-size that avoids truncation of text included in the identified content item when the text is rendered in a content item frame.

7. The method of claim 6, wherein the maximum displayable font-size is determined based on a map of dimensions that fit a model content item.

8. The method of claim 7, wherein the model content item is based on an average amount of text in a sampling of content items contained in a database.

9. The method of claim 7, wherein the model content item is based on the 95^{th} percentile of an amount of text in a sampling of content items contained in a database.

10. The method of claim 7, wherein the model content item comprises the identified content item.

11. The method of claim 1, wherein the optimal font-size prevents a pre-determined percentage of truncations of text included in a plurality of content items.

12. A computer storage medium encoded with a computer program, the program comprising instructions that when executed by data processing apparatus cause the data processing apparatus to perform operations comprising:
receiving a request for a content item;
identifying a content item eligible to fulfill the request, the identified content item including text;
initializing a set of constraints for rendering the identified content item;
based on the initialized set of constraints, determining an optimal font-size for rendering text included in the identified content item; and
delivering the identified content item and an indication of the determined optimal font-size to a device for presentation.

13. The method of claim 12, wherein the identified content item comprises a textual advertisement and the request is received from an application executing on the device.

14. The computer storage medium of claim 12, wherein the set of constraints includes two or more degrees of freedom and determining the optimal font-size for rendering text included in the identified content item includes:
determining an optimal font-size for each configuration of the degrees of freedom; and
selecting the configuration that yielded the maximum optimal font-size.

15. The computer storage medium of claim 14, wherein the optimal font size is the maximum optimal font-size and wherein delivering includes delivering the configuration that yielded the maximum optimal font-size to the device.

16. The computer storage medium of claim 12, wherein the set of constraints comprises a quantity of content items to be displayed in a content item frame, a width of the content item frame, a height of the content item frame, one or more resource provider controls, and one or more environmental variables for the user device.

17. The computer storage medium of claim 12, wherein the optimal font-size is the maximum displayable font-size that avoids truncation of text included in the identified content item when the text is rendered in a content item frame.

18. The computer storage medium of claim 17, wherein the maximum displayable font-size is determined based on a map of dimensions that fit a model content item.

19. The computer storage medium of claim 18, wherein the model content item is based on an average amount of text in a sampling of content items contained in a database.

20. The computer storage medium of claim 18, wherein the model content item is based on the 95^{th} percentile of an amount of text in a sampling of content items contained in a database.

21. The computer storage medium of claim 18, wherein the model content item comprises the identified content item.

22. The computer storage medium of claim 12, wherein the optimal font-size prevents a pre-determined percentage of truncations of text included in a plurality of content items.

23. A system comprising:
a processor configured to execute instructions;
memory configured to store instructions for execution by the processor to cause the system to perform operations comprising:
receiving a request for a content item;
identifying a content item eligible to fulfill the request, the identified content item including text;
initializing a set of constraints for rendering the identified content item;
based on the initialized set of constraints, determining an optimal font-size for rendering text included in the identified content item; and
delivering the identified content item and an indication of the determined optimal font-size to a device or presentation.

24. The system of claim 23, wherein the identified content item comprises a textual advertisement and the request is received from an application executing on the device.

25. The system of claim 23, wherein the set of constraints includes two or more degrees of freedom and determining the optimal font-size for rendering text included in the identified content item includes:
determining an optimal font-size for each configuration of the degrees of freedom; and
selecting the configuration that yielded the maximum optimal font-size.

26. The system of claim 25, wherein the optimal font size is the maximum optimal font-size and wherein delivering includes delivering the configuration that yielded the maximum optimal font-size to the device.

27. The system of claim 23, wherein the set of constraints comprises a quantity of content items to be displayed in a content item frame, a width of the content item frame, a height of the content item frame, one or more resource provider controls, and one or more environmental variables for the user device.

28. The system of claim 23, wherein the optimal font-size is the maximum displayable font-size that avoids truncation of text included in the identified content item when the text is rendered in a content item frame.

29. The system of claim 28, wherein the maximum displayable font-size is determined based on a map of dimensions that fit a model content item.

30. The system of claim 29, wherein the model content item is based on an average amount of text in a sampling of content items contained in a database.

31. The system of claim 29, wherein the model content item is based on the 95^{th} percentile of an amount of text in a sampling of content items contained in a database.

32. The system of claim 29, wherein the model content item comprises the identified content item.

33. The system of claim 23, wherein the optimal font-size prevents a pre-determined percentage of truncations of text included in a plurality of content items.
